(19) United States
(12) Patent Application Publication
(10) Pub. No.: US 2022/0180315 A1
(43) Pub. Date: Jun. 9, 2022

(54) LOGISTICS MANAGING METHOD AND ELECTRONIC APPARATUS PERFORMING THE SAME

(71) Applicant: Coupang Corp., Seoul (KR)

(72) Inventors: Jong Won Lee, Seoul (KR); Ji Won Hwang, Seoul (KR); Sun Hee Hwang, Seoul (KR); Woo Jung Park, Seoul (KR); Myung Soo Song, Seoul (KR)

(21) Appl. No.: 17/136,622

(22) Filed: Dec. 29, 2020

(30) Foreign Application Priority Data
Dec. 4, 2020 (KR) 10-2020-0168326

(51) Int. Cl. G06Q 10/08

(52) U.S. Cl. CPC G06Q 10/08355; G06Q 10/087; G06Q 10/0833; G06Q 10/0832

(57) ABSTRACT

According to various example embodiments, a logistics management method includes identifying attribute information of an item transported to a first fulfillment center and providing destination information of a tote corresponding to the item based on the attribute information of the item, wherein the attribute information of the item includes information regarding whether the item is a target to be transferred to another fulfillment center. In addition, other various embodiments are possible.

### BACKGROUND

### Technical Field

Example embodiments of the present disclosure relate to a logistics management method and an electronic apparatus performing the same.

### Description of the Related Art

As the use of the Internet becomes familiar, the e-commerce market is expanding. Transactions in the e-commerce market take place online through a network, and products that have been traded in e-commerce may be delivered to a destination set by a customer through a delivery service. As the e-commerce market is expanding, a trading brokerage service that mediates a sale between a seller and a buyer and provides the delivery service is also being activated.

For example, a logistics management system for providing the trading brokerage service may request (e.g., place) an order from a seller for a predetermined quantity of items through a specific fulfillment center and store the items received from the seller in a warehouse of the fulfillment center. When a request (e.g., order) for delivery of the items is made by a purchaser, the system may ship the corresponding items from the warehouse and deliver the items to the purchaser through a courier.

Specifically, a procedure for storing (or keeping) items in a fulfillment center may sequentially include a step of placing an order for an item from a specific fulfillment center to a seller, a step of receiving the ordered item from the seller, a step of unloading the item delivered to the fulfillment center, a step of inspecting the unloaded item, a step of warehousing the inspected item in the fulfillment center, and a step of displaying the item in a designated location in the warehouse.

### SUMMARY

### Technical Goals

Meanwhile, a logistics management system may provide as many fulfillment centers as possible in order to provide a more improved training brokerage service. In this case, a seller may have to receive individual orders for a predetermined quantity of items from a plurality of fulfillment centers and deliver the items corresponding to the quantity to each fulfillment center, which may be a burden for the seller.

To solve this, the logistic managing system may place an order, at a base fulfillment center, for the items of the quantity to be ordered from the plurality of fulfillment center at once. The seller may deliver the items corresponding to the ordered quantity to the base fulfillment center, so that the ordered items (stock) are transferred from the base fulfillment center to other fulfillment centers. Through this, a delivery burden of the seller may be minimized.

However, in this case, the received items ordered at the base fulfillment center may be unloaded, inspected, warehoused, and displayed in the base fulfillment, and then picked again to be transferred to another fulfillment center, which may increase a workload of the logistics management service.

To solve the above issues, the present disclosure provides a method and apparatus for transferring items (stock) from a specific fulfillment center to another fulfillment center (other fulfillment centers) with increased efficiency.

### Technical Solutions

According to an aspect, there is provided a logistics management method including identifying attribute information of an item transported to a first fulfillment center and providing destination information of a tote corresponding to the item based on the attribute information of the item, wherein the attribute information of the item includes information on or regarding whether the item is a target to be transferred to another fulfillment center.

The destination information of the tote may include at least one of destination information associated with a task for displaying the item in a designated position of the first fulfillment center, or destination information associated with a task for classifying the item to another tote corresponding to the other fulfillment center to transfer the item to the other fulfillment center.

The logistics management method may further include providing information on or regarding at least one transfer candidate fulfillment center capable of receiving the item and transferable quantity information of the item corresponding to the transfer candidate fulfillment center based on the attribute information of the item in response to a determination that the item corresponds to a target to be transferred to the other fulfillment center.

The logistics management method may further include determining a second fulfillment center to transfer the item among the at least one transfer candidate fulfillment center based on a user input, and determining a transfer quantity of the item to be transferred to the second fulfillment center.

The transfer quantity of the item to be transferred to the second fulfillment center may be determined to be less than or equal to a transferable quantity corresponding to the second fulfillment center based on the user input.

The transferable quantity information may include quantity information in units of a box that contains a predetermined number of items and remaining item quantity information less than the predetermined number of items.

The logistics management method may further include providing information for instructing to perform, on the item to be transferred to the second fulfillment center, an inspection task, an inbound task, and a transfer distribution task in the first fulfillment center, and then to perform a display task on the item after the item is unloaded in the second fulfillment center.

The logistics management method may further include providing type information of an item to be accommodated in the tote based on the attribute information of the item such that items corresponding to a same attribute are accommodated in one tote.

According to another aspect, there is also provided an electronic apparatus including a transceiver and a processor electrically connected to the transceiver, wherein the processor is set to identify attribute information of an item transported to a first fulfillment center and provide destination information of a tote corresponding to the item based on the attribute information of the item, and wherein the attribute information of the item includes information on or regarding whether the item is a target to be transferred to another fulfillment center instead of the first fulfillment center.

According to another aspect, there is also provided a non-transitory computer readable recording medium including a computer program for performing a logistics management method, the method including identifying attribute information of an item transported to a first fulfillment center and providing destination information of a tote corresponding to the item based on the attribute information of the item, wherein the attribute information of the item includes information on or regarding whether the item is a target to be transferred to another fulfillment center.

### Effects

According to example embodiments of the present disclosure, it is possible to provide an electronic apparatus with a method of more efficiently transferring items from a specific fulfillment center to at least one another fulfillment center.

In particular, it is possible to reduce costs for logistics management by preventing a redundant procedure in a warehousing process and a transfer process of an item and also reducing a delivery burden of a seller while providing a quick delivery service to a purchaser.

### BRIEF DESCRIPTION OF THE DRAWINGS

FIG. 1 is a block diagram illustrating a logistics management system according to various example embodiments of the present disclosure.

FIG. 2 is a diagram illustrating a logistics processing procedure performed in a logistics management system according to an example embodiment of the present disclosure.

FIG. 3 is a diagram illustrating an order of tasks performed when transferring an item according to an example embodiment of the present disclosure.

FIG. 4 is a flowchart illustrating a logistics management method according to an example embodiment of the present disclosure.

FIG. 5 is a diagram illustrating an example of a screen on which information is provided in an electronic apparatus when performing an inbound task according to an example embodiment of the present disclosure.

FIGS. 6A through 6G are diagrams illustrating examples of a screen on which information is provided in an electronic apparatus when performing a transfer classification task according to various example embodiments of the present disclosure.

FIG. 7 is a block diagram illustrating an electronic apparatus according to an example embodiment of the present disclosure.

### DETAILED DESCRIPTION

The terms used in the embodiments are selected, as much as possible, from general terms that are widely used at present while taking into consideration the functions obtained in accordance with the present disclosure, but these terms may be replaced by other terms based on intentions of those skilled in the art, customs, emergence of new technologies, or the like. Also, in a particular case, terms that are arbitrarily selected by the applicant of the present disclosure may be used. In this case, the meanings of these terms may be described in corresponding description parts of the disclosure. Accordingly, it should be noted that the terms used herein should be construed based on practical meanings thereof and the whole content of this specification, rather than being simply construed based on names of the terms.

In the entire specification, when an element is referred to as “including” another element, the element should not be understood as excluding other elements so long as there is no special conflicting description, and the element may include at least one other element. In addition, the terms “unit” and “module”, for example, may refer to a component that exerts at least one function or operation, and may be realized in hardware or software, or may be realized by combination of hardware and software.

The expression “at least one of A, B, and C” may include the following meanings: A alone; B alone; C alone; both A and B together; both A and C together; both B and C together; and all three of A, B, and C together.

The term “terminal” mentioned below may be implemented as a computer or a portable terminal capable of accessing a server or another terminal through a network. Here, the computer may include, for example, a laptop computer, a desktop computer, and a notebook equipped with a web browser. The portable terminal may be a wireless communication device ensuring a portability and a mobility, and include any type of handheld wireless communication device, for example, a tablet PC, a smartphone, a communication-based terminal such as international mobile telecommunication (IMT), code division multiple access (CDMA), W-code division multiple access (W-CDMA), and long term evolution (LTE).

In the following description, embodiments of the present disclosure will be described in detail with reference to the drawings so that those skilled in the art can easily carry out the present disclosure. The present disclosure may be embodied in many different forms and is not limited to the embodiments described herein.

Hereinafter, example embodiments of the present disclosure will be described in detail with reference to the accompanying drawings.

In describing the embodiments, descriptions of technical contents that are well known in the art to which the present disclosure belongs and are not directly related to the present specification will be omitted. This is to more clearly communicate without obscuring the subject matter of the present specification by omitting unnecessary description.

For the same reason, in the accompanying drawings, some components are exaggerated, omitted or schematically illustrated. In addition, the size of each component does not fully reflect the actual size. The same or corresponding components in each drawing are given the same reference numerals.

Advantages and features of the present disclosure and methods of achieving them will be apparent from the following exemplary embodiments that will be described in more detail with reference to the accompanying drawings. It should be noted, however, that the present disclosure is not limited to the following exemplary embodiments, and may be implemented in various forms. Accordingly, the exemplary embodiments are provided only to disclose the present disclosure and let those skilled in the art know the category of the present disclosure. In the drawings, embodiments of the present disclosure are not limited to the specific examples provided herein and are exaggerated for clarity. The same reference numerals or the same reference designators denote the same elements throughout the specification.

At this point, it will be understood that each block of the flowchart illustrations and combinations of flowchart illustrations may be performed by computer program instructions. Since these computer program instructions may be mounted on a processor of a general-purpose computer, special purpose computer, or other programmable data processing equipment, those instructions executed through the computer or the processor of other programmable data processing equipment may create a means to perform the functions be described in flowchart block(s). These computer program instructions may be stored in a computer usable or computer readable memory that can be directed to a computer or other programmable data processing equipment to implement functionality in a particular manner, and thus the computer usable or computer readable memory. It is also possible for the instructions stored in to produce an article of manufacture containing instruction means for performing the functions described in the flowchart block(s). Computer program instructions may also be mounted on a computer or other programmable data processing equipment, such that a series of operating steps may be performed on the computer or other programmable data processing equipment to create a computer-implemented process to create a computer or other programmable data. Instructions for performing the processing equipment may also provide steps for performing the functions described in the flowchart block(s).

In addition, each block may represent a portion of a module, segment, or code that includes one or more executable instructions for executing a specified logical function(s). It should also be noted that in some alternative implementations, the functions noted in the blocks may occur out of order. For example, the two blocks shown in succession may in fact be executed substantially concurrently, or the blocks may sometimes be executed in the reverse order, depending on the corresponding function.

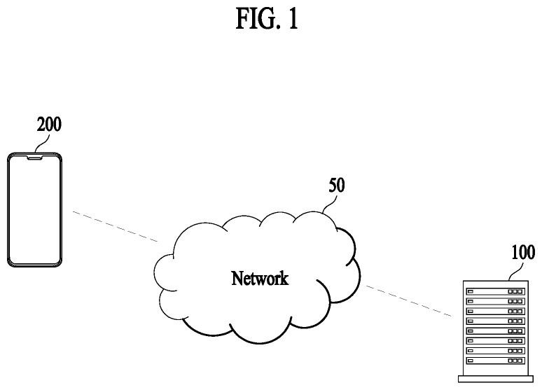

FIG. 1 is a block diagram illustrating a logistics management system according to various example embodiments of the present disclosure.

According to various example embodiments, a logistics management system may include an electronic apparatus 100 (e.g., server), a user terminal 200, and a network 50.

The electronic apparatus 100 (e.g., server) may be a device for handling various processes for logistics management and may manage various task processing related to, for example, display and stock management of items received in a fulfillment center, transport management of the items in the fulfillment center, or picking, classification, and packing of the items. In addition, the electronic apparatus 100 may also process tasks of providing order request information to a seller in relation to the stock management of the items, managing inspection information of items received from the seller in response to the order request, or managing transfer distribution of items inspected and received in the fulfillment center.

The electronic apparatus 100 may include a plurality of computer systems implemented as a network server or computer software and may provide various information by configuring the information into a web page. For example, the electronic apparatus 100 may refer to computer software and a computer system connected to a sub-device that communicates with another network server through a computer network such as an intranet or the Internet to receive a request to perform a task, perform the task, and provide a result of the task. In addition, the electronic apparatus 100 may be understood as a broad concept including a series of application programs that operate on a network server and various databases built therein. For example, the electronic apparatus 100 may be implemented using a network server program that is provided in various ways based on an operating system such as DOS, Windows, Linux, UNIX, Mac OS, or the like.

The network 50 may serve to connect the electronic apparatus 100 and the user terminal 200 or connect the electronic apparatus 100 and an external device (not shown). For example, the network 50 may provide an access path so that the user terminal 200 is connected to the electronic apparatus 100 to transmit and receive packet data.

According to an example embodiment of the present disclosure, operations of the logistics management system may be implemented through the electronic apparatus 100. Also, the user terminal 200 may be connected to the logistics management system through the network 50. The electronic apparatus 100 may store information received from the user terminal 200 in a database or provide information stored in the database to the user terminal 200.

According to another example embodiment, the logistics management system may be implemented in the user terminal 200. For example, a user may install and use the logistics management system in a form of an application on the user terminal 200 through the network 50.

The logistics management system according to example embodiments may be implemented as a single physical device or may be implemented as a plurality of physical devices combined organically. For example, some of the components included in the logistics management system may be implemented as one physical device, and some of the components included in the logistics management system may be implemented as another physical device. For example, one physical device may be implemented as a part of the electronic apparatus 100, and another physical device may be implemented as a part of the user terminal 200 or a part of an external device (not shown). In some cases, components included in the logistics management system may be distributed and arranged in different physical devices. The distributed components may be organically combined to perform functions and operations of the logistics management system.

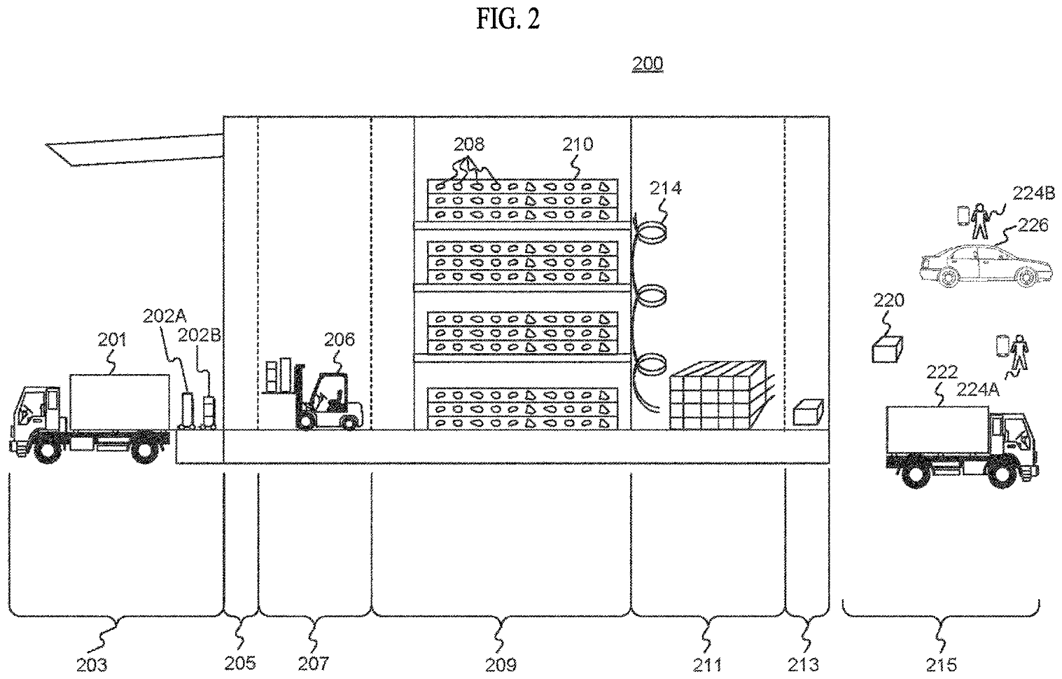

FIG. 2 is a diagram illustrating a logistics processing procedure in a logistics management system according to an example embodiment of the present disclosure.

A fulfillment center (FC) may correspond to a warehouse area in which items to be delivered to purchasers are stored and managed. For example, as illustrated in FIG. 2, the FC may be divided into a plurality of zones 203, 205, 207, 209, 211, 213, and 215. The zones may be virtual separated spaces for explaining a series of handling processes for receiving, storing (or displaying), relocating, retrieving, sorting, shipping, and delivering items. As would be apparent to those skilled in the art, at least some of the above-described plurality of zones may be omitted, further divided, or changed within the scope of various example embodiments of the present disclosure.

A schematic flow of a logistics processing process according to various example embodiments will be described with reference to FIG. 2. Items provided from sellers may be received at a first zone 203 (e.g., inbound zone) of the FC. The received items may be transferred through a second zone 205 (e.g., buffer zone) and a third zone 207 (e.g., drop zone) to a fourth zone 209 (e.g., picking zone) so as to be stored. In response to an order for a specific item being received from a purchaser, items picked from the fourth zone 209 may be accommodated in a tote (or tote box) and transmitted to a fifth zone 211 (e.g., packing zone) through a predetermined carrier 214 for packaging. The items packed in the fifth zone 211 may be stored in a sixth zone 213 (e.g., hub zone) to be shipped (outbound) by a courier. The items may be delivered from a seventh zone 215 (e.g., camp zone) to respective destinations.

Specifically, in the first zone 203, items 202A and 202B received from a seller may be received in the FC. The seller may transmit the items 202A and 202B to the FC using transportation, for example, a truck 201. In the first zone 203, the operator may identify a type of the received item, a quantity of the received item, whether the item is damaged, and the like and provide related information to the user terminal 200 (or the electronic apparatus 100). For example, the operator may transmit only an item satisfying a predetermined condition to the second zone 205.

Meanwhile, in terms of the items according to various example embodiments, attribute information of the corresponding item may be identified in a step of unloading the items from the truck, a step of inspecting whether the items are damaged, or a step of receiving the items in the FC. When the item corresponds to a target to be transferred, the item is transmitted to a separate zone for performing a transfer classification task. When the item corresponds to a non-transfer target, the item may be transmitted to the second zone 205.

The second zone 205 may correspond to a space that serves as a preliminary storage for the fourth zone 209 (e.g., picking zone). For example, when an item of a quantity greater than or equal to an expected quantity to be ordered is stored in the fourth zone 209, and when an item of the same type is received, the corresponding items may be temporarily stored in the second zone 205. When an additional storage of the item is requested in the fourth zone 209, the operator may move the items stored in the second zone 205 to the third zone 207, and then move the items moved to the third zone 207 to the fourth zone 209 again. The relocating task may be performed using, for example, a forklift 206.

The third zone 207 may correspond to a place in which the items are stored until the items are placed in the fourth zone 209. In the third zone 207, the operator may identify (e.g., scan) identification information (e.g., barcode) of the items using the user terminal 200 and transfer the items to the fourth zone 209. The items moved to the fourth zone 209 may be placed in predetermined storage areas (e.g., shelves, boxes, totes, refrigerators, freezers, etc.) of the fourth zone 209.

For example, the fourth zone 209 may include a plurality of floors, each having a storage area 210. In the fourth zone 209, the operator may receive task instruction information indicating that items 208 are to be placed in a predetermined location of the storage area 210 through the user terminal 200 and place the items 208 in the predetermined location of the storage area 210 based on the task instruction information. For example, the operator may identify identification information (e.g., barcode) of the items 208 to be placed using the user terminal 200 and identify identification information (e.g., barcode) corresponding to the predetermined location of the storage area 210 in which the items 208 are to be placed. As such, the operator may provide information associated with a location in which the items 208 are to be placed in the fourth zone 209 to the user terminal 200 (or the electronic apparatus 100).

Meanwhile, at least some of the items placed in the fourth zone 209 may be picked based on picking task instruction information generated in response to an order request from a purchaser and accommodated in at least one tote (or tote box). For example, in the fourth zone 209, the operator may receive task instruction information indicating to retrieve and pick a portion of the items placed in the storage area 210 through the user terminal 200 and perform a picking task based on the task instruction information.

The tote including the picked item may be moved to a destination where a subsequent task is to be performed. The tote may be moved to, for example, a station in which a packing task is to be performed or a station in which a sorting task is to be performed. The electronic apparatus 100 may determine a destination (station) to which the tote is to be moved based on an attribute of the item included in the tote and provide related information to the operator.

For example, the operator may deliver the tote to a predetermined destination of the fifth zone 211 using the predetermined carrier 214 (e.g., conveyor belt, elevator, cart, hand truck, dolly, etc.).

The fifth zone 211 may include a stage area in which a packing task is performed using boxes, bags, or plastic to deliver the item received from the fourth zone 209 to the purchaser. Also, the fifth zone 211 may further include a stage area in which a sorting task of the item is performed before the packing task is performed.

In the sixth zone 213, a packed item 220 transferred from the fifth zone 211 may be temporarily stored. The packed item stored in the sixth zone 213 may be transferred to the seventh zone 215 based on an address. In the seventh zone 215, couriers 224A and 224B may deliver the packed item 220 to a destination of the address using various types of transportations 222 and 226.

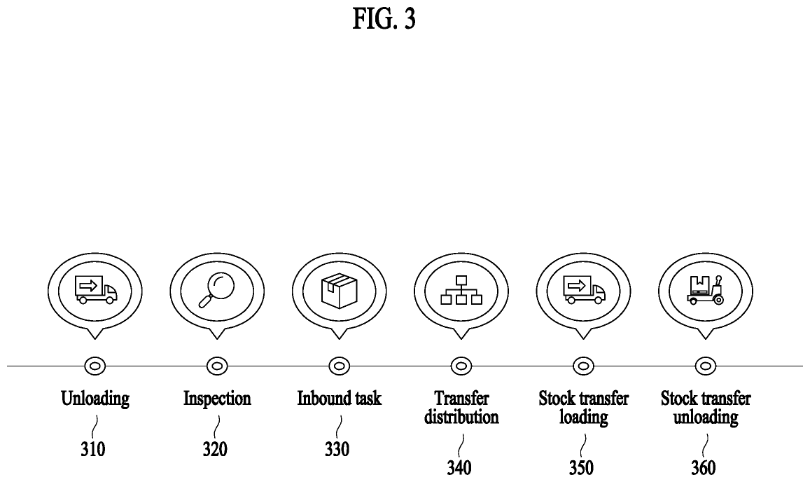

FIG. 3 is a diagram illustrating an order of tasks performed when transferring an item according to an example embodiment of the present disclosure.

Referring to FIG. 3, in a logistics management system according to an example embodiment, tasks may be performed on an item in an order of an unloading task 310, an inspection (or checking) task 320, an inbound task 330, a transfer distribution task 340, a stock transfer loading task 350, and a stock transfer unloading task 360.

An item of a predetermined quantity ordered from a specific fulfillment center (e.g., a first fulfillment center) may be sent from a seller and unloaded in the fulfillment center. For example, an operator performing the unloading task 310 may scan order placement information (e.g., order sheet information) on the order placed by the fulfillment center such that the electronic apparatus 100 identifies the order placement information. Through this, the electronic apparatus 100 may identify whether the sent item is an item to be transferred based on the order placement information and provide (e.g., display) the operator with information on or associated with whether the item is to be transferred.

Meanwhile, after the unloading task 310, the inspection task 320 may be performed on the unloaded item. While the inspection task 320 is performed, whether the item is damaged and/or whether there is a problem such as an omission of an item quantity may be identified. In the example embodiment, the inspection task 320 may be performed after the unloading task 310 and before the inbound task 330 but is not limited thereto. In some cases, the inspection task 320 and one of the unloading task 310 or the inbound task 330 may be performed at the same time or redundantly.

The inbound task 330 may be performed in a predetermined inbound task area. According to an example embodiment, in terms of the inbound task 330, the electronic apparatus 100 may provide information for guiding tasks to be performed at different task tables based on attributes of items. For example, the electronic apparatus 100 may identify whether a specific item corresponds to a transfer target item to be transferred to another fulfillment center instead of the fulfillment center in which an inbound task of the item is performed. When the item is determined to be the transfer target item, the electronic apparatus 100 may provide relevant information such that the corresponding item is received in accordance with a set condition. For example, the electronic apparatus 100 may provide information for guiding items to be transferred to another fulfillment center are distinguished from other items and accommodated in a specific tote. Through this, the item corresponding to the transfer target item may be distinguished from items corresponding to non-transfer target items and accommodated in a specific tote. According to an example embodiment, the electronic apparatus 100 may also provide information for guiding only items (or a set of items, for example, stock keeping unit (SKU)) of the same type to be accommodated in one tote.

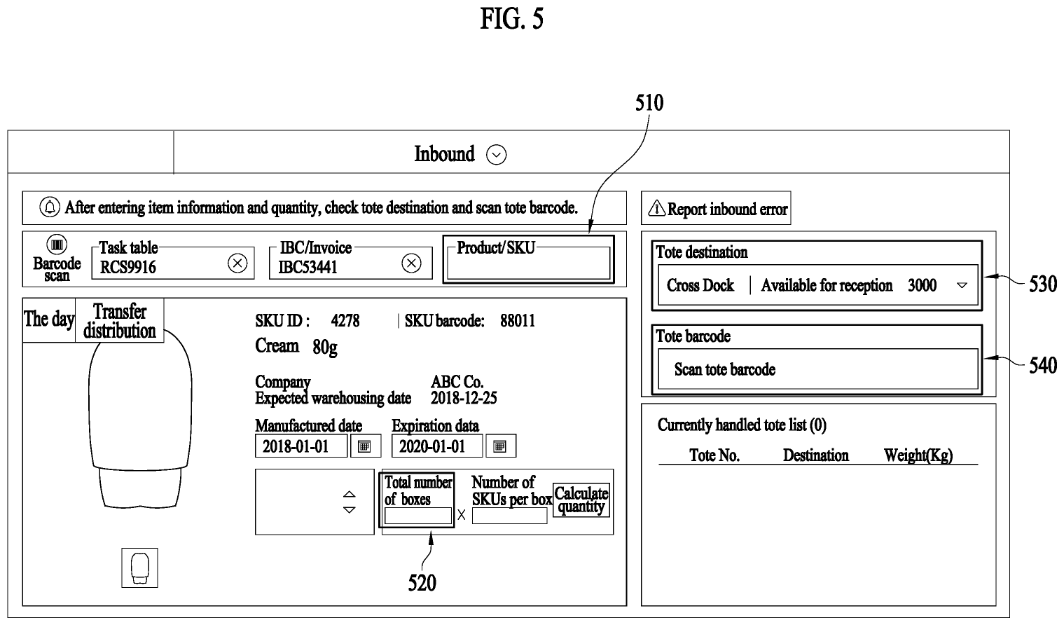

FIG. 5 is a diagram illustrating an example of a screen that provides predetermined information in the electronic apparatus 100 when performing the inbound task 330 according to an example embodiment of the present disclosure.

Referring to FIG. 5, the electronic apparatus 100 according to an example embodiment may identify identification information 510 (or attribute information) of an item in a process of performing an inbound task of an item (or SKU, omitted below) on a task table (e.g., an inbound task table having identification information of “RCS0016”) for performing a predetermined inbound task. For example, the electronic apparatus 100 may scan information of a code (e.g., barcode) attached to the SKU or a specific item and identify the identification information 510 of the item from the scanned information. In addition, the electronic apparatus 100 may identify the identification information 510 by receiving a predetermined search word to search for the identification information 510. Also, the electronic apparatus 100 may receive the identification information 510 directly from a user.

The electronic apparatus 100 may provide destination-related information 530 of a tote corresponding to the item based on the identification information 510 of the tote. For example, the identification information 510 of the item may include information regarding whether the corresponding item is a target to be transferred to another fulfillment center.

When it is determined from the identification information 510 of the item that the item corresponds to a transfer target item to be transferred to another fulfillment center, the electronic apparatus 100 may determine a tote destination corresponding to the item to be “cross dock.” This may correspond to a task area in which items are distributed to a global tote (or global totes) corresponding to a different fulfillment center (or different fulfillment centers) to transfer the item included in a tote corresponding to the tote destination of “cross dock” to one or more different fulfillment centers.

For example, when it is determined from the identification information 510 of the item that the item does not correspond to the transfer target item, the electronic apparatus 100 may provide information on or regarding an area for performing a specific task (e.g., display task) in the corresponding fulfillment center where the item is received, as the destination-related information 530 of the tote.

The electronic apparatus 100 may receive quantity information 520 of the received item in units of a box. A quantity of SKUs or items included in one box may be determined based on an attribute of each item in advance, so as to be automatically displayed in response to the identification information 510 of the item being identified.

In addition, the electronic apparatus 100 may identify identification information 540 (e.g., tote barcode information) of an empty tote for accommodating an inbound item through barcode scanning or based on a user input. The electronic apparatus 100 may store and manage the identified identification information 540 by mapping the identification information 540 and the tote destination information 530. For example, when the identification information of the tote is scanned in a later step, the electronic apparatus 100 may output information such as “cross dock” as the tote destination information 530 corresponding to the tote.

As such, in a process of performing the inspection task 320 and the inbound task 330 on the item after the unloading task 310, the item may be accommodated (or loaded) in a predetermined tote. Also, tote destination information corresponding to an attribute of the item may be managed through the mapping with identification information of the tote.

Referring back to FIG. 3, after the inbound task is completed, the item may be accommodated in the tote and moved to an area for a subsequent task. A location to which the item is moved may correspond to the tote destination information 530 of FIG. 5. For example, when the item is a target to be transferred to another fulfillment center, the transfer target item may be moved to a location in which the transfer distribution task 340 is to be performed. The transfer target item may be distinguished from other items corresponding to non-transfer target items and moved to another task position. For example, the transfer distribution task 340 may not be performed to the non-transfer target items. Instead, the non-transfer target items may be moved to the second zone 205 (e.g., buffer zone and the third zone 207 (e.g., drop zone) so as to be displayed (or arranged) in a designated storage area of the fourth zone 209 (e.g., picking zone) as described with reference to FIG. 2.

The transfer distribution task 340 may correspond to a preparation process for transferring the item to at least one different fulfillment center. For example, in a step of the transfer distribution task 340, a fulfillment center to receive the item and a quantity of the item to be transferred may be set based on a user input. Based on the set information, a task of transferring the item of the specific tote to another tote (e.g., global tote) corresponding to another fulfillment center that is to receive the item may be performed. For example, a delivery destination of the other tote may be set to the other fulfillment center that is to receive the item.

The stock transfer loading task 350 may be performed on the item accommodated in the specific tote through the transfer distribution task 340 so that the item is delivered to the delivery destination of the tote, that is, the other fulfillment center that is to receive the item. After the item arrives at the delivery destination, the stock transfer unloading task 360 may be performed.

In terms of the item on which the stock transfer unloading task 360 is performed, the electronic apparatus 100 may provide information indicating that the item is an item transferred from the other fulfillment center. Through this, the operator may move the item without performing the inspection task 320 on the item such that a display task is performed immediately.

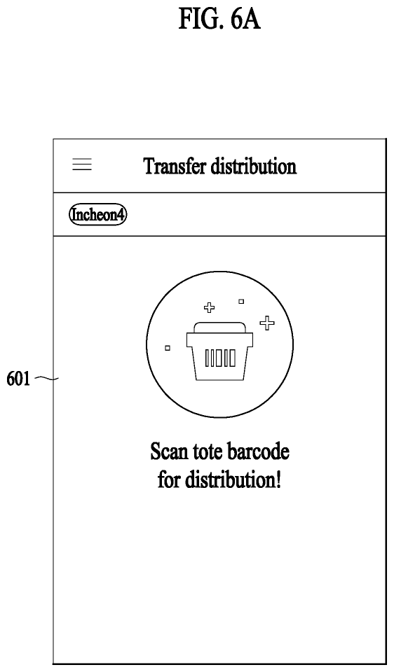

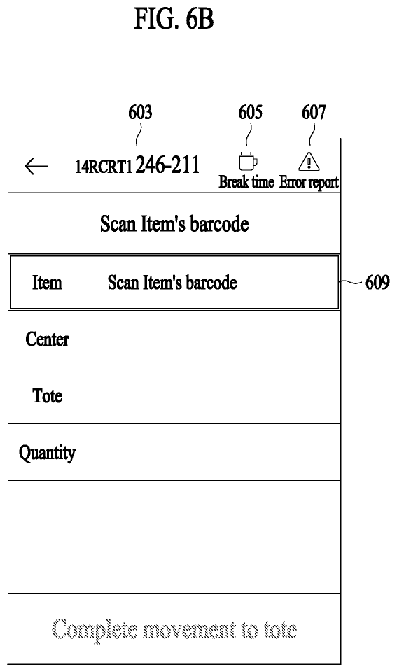

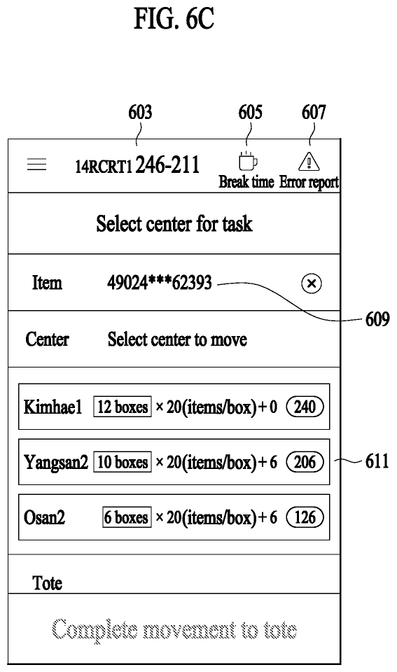

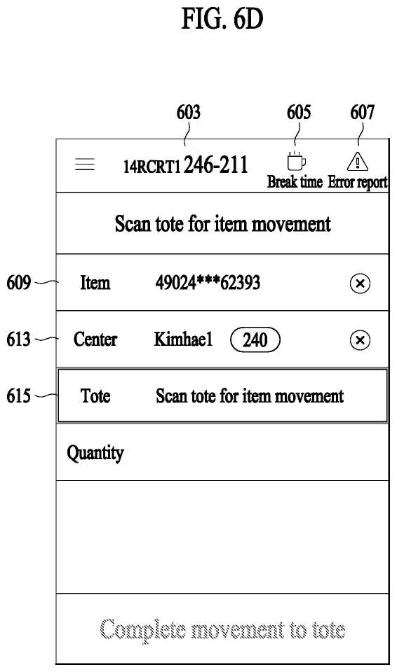

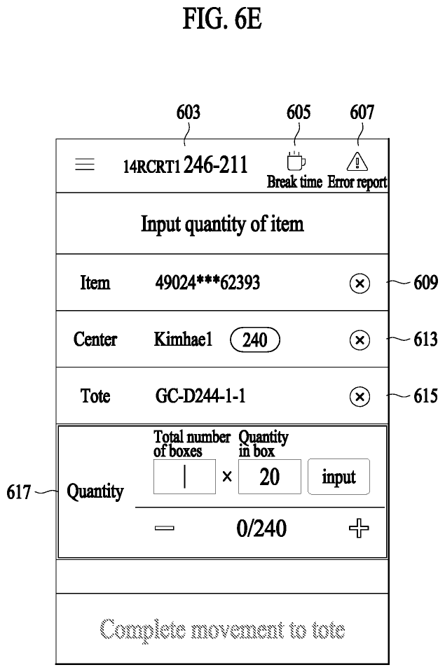

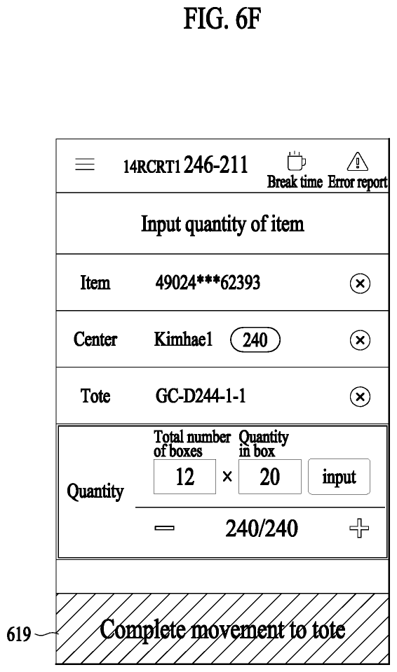

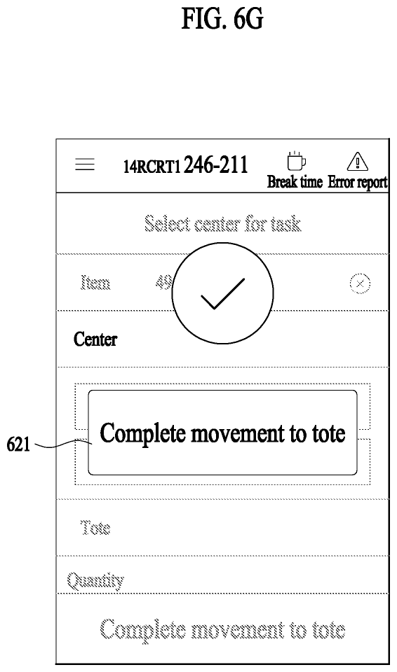

Meanwhile, while the transfer distribution task 340 is performed, the electronic apparatus 100 may provide various information required for the transfer distribution task 340 to the user terminal 200. Related example embodiments will be described later in greater detail with reference to FIGS. 6A through 6G.

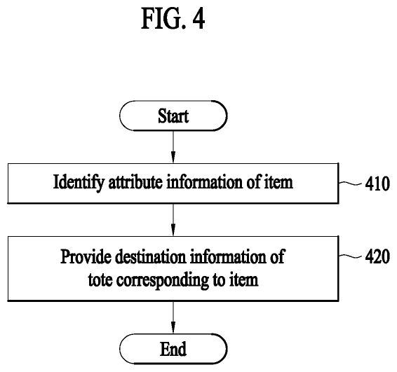

FIG. 4 is a flowchart illustrating a logistics management method according to an example embodiment of the present disclosure.

Referring to FIG. 4, a logistics management method according to an example embodiment may include operation 410 of identifying attribute information of an item. Here, the attribute information of the item may include information on or regarding whether the item is a target to be transferred to another fulfillment center.

For example, an item (or items) delivered to a first fulfillment center from an external seller according to an order placed from the first fulfillment center may be received in the first fulfillment center through the unloading task 310, the inspection task 320, and the inbound task 330 in sequence.

The electronic apparatus 100 according to various example embodiments may identify attribute information of the item based on order placement-related information in a step of the unloading task 310 (refer to FIG. 3) performed after the item is delivered to the first fulfillment center. For example, the order placement-related information may include information indicating that at least some of the items ordered by the first fulfillment center are ordered by the first fulfillment center on behalf of another fulfillment center (or other fulfillment centers).

In addition, in a step of the inbound task 330 (refer to FIG. 3) performed to receive the item into the first fulfillment center, the electronic apparatus 100 may identify attribute information (or the identification information 510 of FIG. 5) of the unloaded item. When the item is a target to be transferred to another fulfillment center, attribute information 609 (refer to FIG. 6C) of an item on which a transfer distribution is to be performed may also be identified in a step of the transfer distribution task 340 (refer to FIG. 3) of the item. For example, the attribute information (or identification information) of the item may be identified by scanning barcode information attached to the item (or SKU).

Subsequently, in operation 420, the electronic apparatus 100 according to various example embodiments may provide destination information of an item or destination information of a tote (for example, a tote containing the item) corresponding to the item. For example, the electronic apparatus 100 may identify destination information of a tote corresponding to the item based on the attribute information of the item identified in operation 410 and provide (e.g., display) the identified destination information of the tote.

In various example embodiments, the attribute information of the item may include information regarding whether the item corresponds to a target to be transferred from the first fulfillment center to other external fulfillment centers. Also, the destination information of the tote corresponding to the item may be provided differently in accordance with an attribute of the item based on whether the item is a transfer target item or a non-transfer target item.

For example, in the step of the unloading task 310 or the inbound task 330 of the item, when the item is determined to be the transfer target item, the electronic apparatus 100 may provide predetermined information (e.g., destination information) so that the item is distinguished from other items (non-transfer target items) and managed separately.

For example, an operator who performs the inbound task 330 of the item may collect the transfer target item and the non-transfer target item for respective totes based on tote destination information provided from the electronic apparatus 100 such that the non-transfer target item is not collected to a tote containing the transfer target item. Further, even if all items (or SKUs) of various types correspond to transfer target items, the electronic apparatus 100 according to an example embodiment may subdivide information of a tote corresponding to each item and provide the information so that items of the same type are collected in one tote.

In addition, in the step of the transfer distribution task 340 of the item, when the item is determined to be the transfer target item, the electronic apparatus 100 may provide information of at least one transfer candidate fulfillment center that is to receive the item, as the destination information of the tote corresponding to the item. Also, the electronic apparatus 100 may additionally provide transferable item quantity information corresponding to each of the at least one transfer candidate fulfillment center.

In various example embodiments of the present disclosure, the electronic apparatus 100 may separately manage the transfer target item and the non-transfer target item in each step, thereby providing information. Through this, the transfer target item may be handled through the unloading step, the inspection step, and the inbound step without being mixed with the non-transfer target item. In particular, the electronic apparatus 100 may provide information for guiding a movement to a destination for performing the transfer distribution task such that a separate picking task is not performed on the received transfer target item after the transfer target item arrives at and displayed in the fulfillment center. Through this, the inspection task and the display task may not be redundantly performed in the fulfillment center from which the order is placed and the fulfillment center to which the item is transferred.

FIGS. 6A through 6G are diagrams illustrating screens showing various information provided in an electronic apparatus according to various example embodiments of the present disclosure. For example, FIGS. 6A through 6G correspond to user interfaces displayed on the user terminal 200 corresponding to an operator who performs a transfer distribution task. Hereinafter, with reference to FIGS. 6A through 6G, a description will be given of a transfer distribution task scheme of an item according to various example embodiments of the present disclosure.

The electronic apparatus 100 according to various example embodiments may receive predetermined user input information input through the user terminal 200. Also, the electronic apparatus 100 may provide (e.g., display) predetermined information to a user (or operator) through the user terminal 200.

In FIG. 6A, the electronic apparatus 100 may provide a guide screen 601 instructing to scan identification information of a target tote for a transfer distribution task. For example, a fulfillment center (e.g., fulfillment center “Incheon4”) in which the transfer distribution task is performed may correspond to a basic fulfillment center that places an order for the corresponding item to a seller. The electronic apparatus 100 may provide information to a user by outputting the screen information through the user terminal 200.

In this instance, the user terminal 200 may acquire, by an operator, identification information (e.g., tote barcode information) of the target tote for the transfer distribution task. For example, an operator who performs the transfer distribution task may scan identification information attached to the tote using at least one sensor provided in the user terminal 200. The user terminal 200 may provide the scanned tote identification information to the electronic apparatus 100.

Accordingly, as illustrated in FIGS. 6B and 6C, scanned identification information 603 (e.g., “14RCRT1 246-211”) of the target tote for the transfer distribution task may be displayed on one side of the screen.

Additionally, a notification message instructing to scan identification information 609 (e.g., product barcode information) of a specific item (or product) included in the tote may be displayed on the screen (refer to FIG. 6B).

In accordance with the notification message, the operator may scan the identification information of the specific item using at least one sensor of the user terminal 200. The scanned identification information may be provided to the electronic apparatus 100, so that the identification information 609 (e.g., “49024***62393”) of the item is applied to and displayed on the screen (refer to FIG. 6C).

Meanwhile, the electronic apparatus 100 according to various example embodiments may identify attribute information of the item based on the identification information 609 of the item received from the user terminal 200.

The electronic apparatus 100 may identify information 611 of at least one transfer candidate fulfillment center capable of receiving (or having to receive) the item, transmit the information to the user terminal 200, and display the information on the screen of the user terminal 200. For example, the electronic apparatus 100 may identify the information 611 of the at least one transfer candidate fulfillment center from a predetermined supply chain management system.

For example, as illustrated in FIG. 6C, a fulfillment center “Kimhae1”, a fulfillment center “Yangsan2”, and a fulfillment center “Osan2” may be presented as the information 611 of the at least one transfer candidate fulfillment center capable of receiving (or having to receive) a specific item.

Meanwhile, regarding the information 611 of the transfer candidate fulfillment center, the electronic apparatus 100 may provide maximum transferable quantity information regarding a quantity to which each transfer candidate fulfillment center is capable of receiving the transferred item.

In particular, according to an example embodiment, the maximum transferable quantity information may include quantity information (e.g., 12 boxes, 10 boxes, and 6 boxes) provided in units of a box containing items of a number or quantity (e.g., qty. 20) determined based on an attribute of each item in advance and remaining item quantity information (e.g., qty. 0, qty. 6, and qty. 6) provided in units of items of the determined number or less. In addition, the maximum transferable quantity information may further include total quantity information (e.g., qty. 240, qty. 206, and qty. 126) regarding a total quantity of the item. As such, the electronic apparatus 100 may provide relevant information so that the transfer distribution task is performed by managing items to be transferred in units of boxes.

In various example embodiments of the present disclosure, the description is given based on a quantity of “item” for ease and convenience. However, as discussed in the foregoing explanation, the quantity of “item” can be interchangeably understood as a quantity of “SKU” corresponding to a set of items (e.g., 1 set of packaged products, 5 bags of ramen, a fruit set, etc.).

Next, referring to FIG. 6D, the electronic apparatus 100 may receive a user input of selecting a fulfillment center from the at least one transfer candidate fulfillment center through the user terminal 200.

For example, in response to a reception of a user input of determining the fulfillment center “Kimhae1” to be a fulfillment center that is to receive a transferred item (hereinafter, referred to as a “second fulfillment center”) based on the information 611 of a plurality of transfer candidate fulfillment centers provided in FIG. 6C, the electronic apparatus 100 may display information 613 (e.g., “Kimhae1”) of the determined second fulfillment center on the screen (refer to FIG. 6D). In this example, as illustrated in FIG. 6D, maximum transferable quantity information (e.g., qty. “240”) regarding a quantity to which the determined second fulfillment center is capable of receiving the item may be additionally displayed.

Subsequently, the electronic apparatus 100 may display a notification message instructing to scan information 615 on a new tote (for example, a global tote) for collecting an item to be transferred to the selected transfer target fulfillment center, that is, the second fulfillment center (e.g., the fulfillment center “Kimhae1”). Accordingly, the operator may scan identification information (e.g., tote barcode information) attached to an empty tote (e.g., the global tote) for containing the item to be transferred to the second fulfillment center using the user terminal 200 and provide the identification information of the tote to the electronic apparatus 100. The electronic apparatus 100 may map the identification information 615 of the tote and information indicating that the tote for collecting is the global tote to be moved to the second fulfillment center and store a mapping result.

Meanwhile, based on information obtained by scanning the identification information of the specific (global) tote in the example of FIG. 6D, when a destination of the (global) tote is a fulfillment center other than the determined second fulfillment center, instead of displaying the scanned tote identification information as illustrated in FIG. 6E, the electronic apparatus 100 may output information (not shown) instructing to scan another global tote and attempt at the transfer distribution task.

For example, based on the identification information of the scanned (global) tote, when the destination of the global tote is set, the electronic apparatus 100 may determine the global tote as an available tote only for a case in which the destination corresponds to the second fulfillment center. In addition, even when the destination of the (global) tote is not set, the electronic apparatus 100 may determine the (global) tote as the available tote.

Referring to FIGS. 6E and 6F, when the electronic apparatus 100 determines the (global) tote to be an available tote, the electronic apparatus 100 may provide the identification information 615 (e.g., GC-D244-1-1) of the (global) tote to which the item is to be moved.

Also, the electronic apparatus 100 may additionally display, on the screen, a field 617 for inputting quantity information of an item to be moved to the second fulfillment center by a new (global) tote to which the item is to be transferred.

For example, the field 617 for inputting the quantity information of the item to be transferred to the second fulfillment center may be configured to receive an input of quantity information (e.g., 12 boxes) in units of a box containing items of the predetermined number (e.g., qty. 20) and configured to adjust information on or regarding a total quantity (e.g., 240) of the item to be transferred to the second fulfillment center, including the number of items accommodated in the box. In this case, the user (or operator) may receive an input of quantity information corresponding to a quantity less than or equal to the maximum transferable quantity, for example, within a range of maximum quantity (e.g., 240) to which the second fulfillment center is capable of receiving a transferred item. The electronic apparatus 100 may determine the input quantity information as a transfer quantity of the item to be transferred to the second fulfillment center only when the quantity information input by the user (or operator) is less than or equal to the maximum transferable quantity information.

As described above, in a case of providing the maximum transferable quantity information of the item to be transferred or receiving a user input related to an actual transfer quantity for transferring an item, the electronic apparatus 100 may provide information on or associated with a quantity for transfer (or transfer distribution) in units of a box, thereby minimizing confusion in determining a quantity when the operator performs the transfer distribution task.

Meanwhile, after a task of moving the item of the determined quantity to the new (global) tote, the operator may provide an input 619 (e.g., an input to a button “Complete movement to tote”) for confirming that the item transfer to a tote to be moved to the fulfillment center “Kimhae1” is completed as illustrated in FIG. 6F. Through this, the electronic apparatus 100 may determine that the item corresponding to a transfer quantity set by the user input is distributed to the new (global) tote to be moved to the second fulfillment center. Also, the electronic apparatus 100 may output notification information 621 (e.g., “Complete movement to tote”) through the user terminal 200 as illustrated in FIG. 6G.

The electronic apparatus 100 may display a field of the information 611 (refer to FIG. 6C) of the transfer candidate fulfillment center, excluding the fulfillment center “Kimhae1” which has been displayed as a transfer candidate fulfillment center available for receiving a transferred item based on the identification information of the item.

Meanwhile, the electronic apparatus 100 according to various example embodiments may output guide information (not shown) associated with a termination of the transfer distribution task for the corresponding tote when all items included in the target tote (e.g., the tote corresponding to the tote identification number scanned in FIG. 6A) for the transfer distribution task are distributed to another (global) tote (e.g., the global tote corresponding to the tote scan number scanned in FIG. 6D), for example, when an input for a field “tote is empty” is received from the operator. Also, in terms of the target tote for the transfer distribution task, when a specific item remains in the tote even after the transfer distribution task is substantially completed, the electronic apparatus 100 may receive information related to a specific problem occurrence situation in response to an input to a field “product remains in tote” being received from the operator.

In addition, the electronic apparatus 100 may provide various usability related to the transfer distribution task by providing a selection field (indicated by reference numeral 605 of FIG. 6B) for inputting when the operator is to take a break during work or a selection field (indicated by reference numeral 607 of FIG. 6B) for inputting when a problem occurs during work, as a user interface screen related to the transfer distribution task.

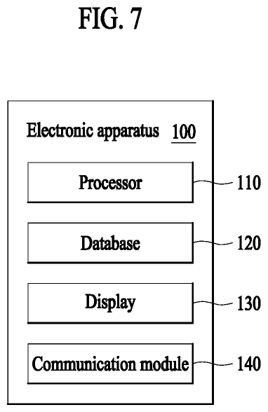

FIG. 7 is a block diagram illustrating an electronic apparatus according to example embodiments of the present disclosure.

Referring to FIG. 7, the electronic apparatus 100 (e.g., server) according to various example embodiments may include at least one of a processor 110, a database 120, a display 130, and a communication module 140.

The processor 110 may process a series of operations for performing a logistics management method according to example embodiments of the present disclosure. The processor 110 may control other components of the electronic apparatus 100 overall.

For example, the processor 110 may provide destination information of a tote containing an item based on attribute information of the item in association with whether the item is a target to be transferred. Based on an attribute of the item, the processor 110 may provide information regarding whether the item or the tote containing the tote is to be moved to a display-related task area of a first fulfillment center, or the item or the tote is to be moved to a transfer distribution task area in which the item is to be classified to another tote so as to be transferred to another fulfillment center instead of the first fulfillment center.

In addition, the processor 110 may identify information on or associated with at least one transfer candidate fulfillment center and provide relevant information when the item corresponds to a transfer target item based on the attribute of the item. The processor 110 may also identify transferable quantity information of the item to be received in the transfer candidate fulfillment center and provide the identified transferable quantity information.

Also, the processor 110 may provide a user interface that provides relevant information required to perform a transfer classification task for distributing the transfer target item to another tote (e.g., a global tote) to be moved to another fulfillment center.

In addition, the processor 110 may execute various functions related to the above-described logistics management according to example embodiments of the present disclosure.

The database 120 may be a data structure implemented in a predetermined storage space of the electronic apparatus 100, where functions such as storing, searching, deleting, editing, or adding data are freely performed. For example, the database 120 may have fields or components for processing functions such as storing, searching, deleting, editing, or adding data.

The database 120 may store data related to various functions of the electronic apparatus 100. For example, the database 120 may store various information associated with a fulfillment center, and in addition, may store instructions or data for an execution operation of the processor 110.

The display 130 may display various information associated with an operation of the electronic apparatus 100. For example, the display 130 may display various information associated with logistics management such as item attribute information, tote destination information, transfer candidate fulfillment center information, and the like. According to an example embodiment, the electronic apparatus 100 may not include the display 130. In this case, the electronic apparatus 100 may provide display information by transmitting the information to be displayed to another device (e.g., the user terminal 200) through the communication module 140, so that the information is displayed on a display included in the other device.

The communication module 140 may perform a function of transmitting information stored in the database 120 of the electronic apparatus 100 or predetermined information processed by the processor 110 to another device, or receiving predetermined information from another device into the electronic apparatus 100. For example, the communication module 140 may receive predetermined user input information from the user terminal 200. In the example embodiment, the communication module 140 may include a transceiver for transmitting and receiving information.

Meanwhile, the present disclosure and drawings have been described with respect to the example embodiments of the present disclosure, although specific terms have been used, they are merely used in a general sense to easily explain the technical contents of the present disclosure and to help understand the present disclosure. It is not intended to limit the scope of the present disclosure. It is apparent to those skilled in the art to which the present disclosure pertains that other modified examples based on the technical idea of the present disclosure can be implemented in addition to the embodiments disclosed herein.

Meanwhile, the present disclosure and drawings have been described with respect to the example embodiments of the present disclosure, although specific terms have been used, they are merely used in a general sense to easily explain the technical contents of the present disclosure and to help understand the present disclosure. It is not intended to limit the scope of the present disclosure. It is apparent to those skilled in the art to which the present disclosure pertains that other modified examples based on the technical idea of the present disclosure can be implemented in addition to the embodiments disclosed herein.

The electronic apparatus or terminal in accordance with the above-described embodiments may include a processor, a memory which stores and executes program data, a permanent storage such as a disk drive, a communication port for communication with an external device, and a user interface device such as a touch panel, a key, and a button. Methods realized by software modules or algorithms may be stored in a computer-readable recording medium as computer-readable codes or program commands which may be executed by the processor. Here, the computer-readable recording medium may be a magnetic storage medium (for example, a read-only memory (ROM), a random-access memory (RAM), a floppy disk, or a hard disk) or an optical reading medium (for example, a CD-ROM or a digital versatile disc (DVD)). The computer-readable recording medium may be dispersed to computer systems connected by a network so that computer-readable codes may be stored and executed in a dispersion manner. The medium may be read by a computer, may be stored in a memory, and may be executed by the processor.

The present embodiments may be represented by functional blocks and various processing steps. These functional blocks may be implemented by various numbers of hardware and/or software configurations that execute specific functions. For example, the present embodiments may adopt direct circuit configurations such as a memory, a processor, a logic circuit, and a look-up table that may execute various functions by control of one or more microprocessors or other control devices. Similarly to that elements may be executed by software programming or software elements, the present embodiments may be implemented by programming or scripting languages such as C, C++, Java, and assembler including various algorithms implemented by combinations of data structures, processes, routines, or of other programming configurations. Functional aspects may be implemented by algorithms executed by one or more processors. In addition, the present embodiments may adopt the related art for electronic environment setting, signal processing, and/or data processing, for example. The terms “mechanism”, “element”, “means”, and “configuration” may be widely used and are not limited to mechanical and physical components. These terms may include meaning of a series of routines of software in association with a processor, for example.

The above-described embodiments are merely examples and other embodiments may be implemented within the scope of the following claims.

1. A method executed by an application-specific integrated circuit
comprising:
scanning an item transported to a first fulfillment center and identifying attribute information of the item, wherein the attribute information of the item comprises information regarding whether the item is a transfer target item to be transferred to a second fulfillment center;
automatically presenting, in response to the attribute information, item quantity information associated with the item;
identifying, by a dedicated hardware logic circuit from scanned data, whether the item was transferred from another fulfillment center or received directly from a seller, wherein upon
identifying that the item was transferred from another fulfillment center, providing information instructing to perform a display task immediately and omitting an inspection task; and
providing, upon determining that the item is the transfer target item, destination information of a tote corresponding to the item based on the attribute information of the item; and
calculating a total number of items assigned to the tote to be less than a maximum transferable quantity associated with the second fulfillment center.

2. The method of claim 1, wherein the destination information of the tote comprises at least one of:
destination information associated with a task for displaying the item in a designated position of the first fulfillment center; or
destination information associated with a task for classifying the item to another tote corresponding to another fulfillment center to transfer the item to another fulfillment center.

3. The method of claim 1, further comprising:
providing information regarding at least one transfer candidate fulfillment center capable of receiving the item and transferable quantity information of the item corresponding to the transfer candidate fulfillment center based on the attribute information of the item in response to a determination that the item corresponds to a target to be transferred to another fulfillment center.

4. The method of claim 3, further comprising:
determining a second fulfillment center to transfer the item among the at least one transfer candidate fulfillment center based on a user input; and
determining a transfer quantity of the item to be transferred to the second fulfillment center.

5. The method of claim 4, wherein the transfer quantity of the item to be transferred to the second fulfillment center is determined to be less than or equal to a transferable quantity corresponding to the second fulfillment center based on the user input.

6. The method of claim 3, wherein the transferable quantity information comprises quantity information in units of a box that contains a predetermined number of items and remaining item quantity information less than the predetermined number of items.

7. The method of claim 4, further comprising:
providing information for instructing to perform, on the item to be transferred to the second fulfillment center, an inspection task, an inbound task, and a transfer distribution task in the first fulfillment center, and then to perform a display task on the item after the item is unloaded in the second fulfillment center.

8. The method of claim 1, further comprising:
providing type information of the item to be accommodated in the tote based on the attribute information of the item such that items corresponding to a same attribute are accommodated in one tote.

9. An electronic apparatus comprising:
a transceiver; and
a processor electrically connected to the transceiver, wherein the processor is configured to execute a high frequency algorithm comprising the steps of:
scan an item transported to a first fulfillment center and identify attribute information of the item, wherein the attribute information of the item comprises information regarding whether the item is a transfer target item to be transferred to a second fulfillment center;
automatically present, in response to the attribute information, item quantity information associated with the item;
identify whether the item was transferred from another fulfillment center or received directly from a seller, wherein upon identifying that the item was transferred from another fulfillment center, providing information for instructing to perform a display task immediately and omitting an inspection task;
provide, upon determining that the item is the transfer target item, destination information of a tote corresponding to the item based on the attribute information of the item; and
calculate a total number of items assigned to the tote to be less than a maximum transferable quantity associated with the second fulfillment center.

10. The electronic apparatus of claim 9, wherein the processor is further configured to provide, as the destination information of the tote, at least one of:
destination information associated with a task for displaying the item in a designated position of the first fulfillment center; or
destination information associated with a task for classifying the item to another tote corresponding to another fulfillment center to transfer the item to another fulfillment center instead of the first fulfillment center.

11. The electronic apparatus of claim 9, wherein the processor is further configured to provide information regarding at least one transfer candidate fulfillment center capable of receiving the item based on the attribute information of the item in response to a determination that the item corresponds to a target to be transferred to another fulfillment center.

12. The electronic apparatus of claim 11, wherein the processor is further configured to determine a second fulfillment center to transfer the item among the at least one transfer candidate fulfillment center based on a user input.

13. The electronic apparatus of claim 12, wherein the processor is further configured to provide a command to perform, on the item to be transferred to the second fulfillment center, an inspection task, an inbound task, and a transfer distribution task in the first fulfillment center, and then to perform a display task on the item after the item is unloaded in the second fulfillment center.

14. The electronic apparatus of claim 12, wherein the processor is further configured to provide type information of the item to be accommodated in the tote based on the attribute information of the item such that items corresponding to a same attribute are accommodated in one tote.

15. A non-transitory computer readable recording medium comprising a computer program for performing a logistics management method, the method comprising:
scanning an item transported to a first fulfillment center and identifying attribute information of the item, wherein the attribute information of the item comprises information regarding whether the item is a transfer target item to be transferred to a second fulfillment center;
automatically presenting, in response to the attribute information, item quantity information associated with the item;
identifying whether the item was transferred from another fulfillment center or received directly from a seller, wherein upon identifying that the item was transferred from another fulfillment center, providing information for instructing to perform a display task immediately and omitting an inspection task;
providing, upon determining that the item is the transfer target item, destination information of a tote corresponding to the item based on the attribute information of the item; and
calculating a total number of items assigned to the tote to be less than a maximum transferable quantity associated with the second fulfillment center.
